(19) United States
(12) Patent Application Publication
(10) Pub. No.: US 2021/0221566 A1
(43) Pub. Date: Jul. 22, 2021

(54) WINDOWED CORNET PACKAGE

(71) Applicant: MONDI KALE NOBEL AMBALAJ SANAYI VE TICARET ANONIM SIRKETI, Kirklareli (TR)

(72) Inventors: Umit SAHIN, Kirklareli (TR); Osman KADIROGLU, Kirklareli (TR)

(21) Appl. No.: 16/099,906

(22) PCT Filed: Nov. 22, 2017
(86) PCT No.: PCT/TR2017/050583

§ 371 Date: Nov. 8, 2018

(30) Foreign Application Priority Data
Jan. 9, 2017 (TR) 2017/00278

(51) Int. Cl. B65D 25/54; A23G 9/50; B65D 3/06; B65D 85/78

(52) U.S. Cl. CPC B65D 25/54; A23G 9/503; B65D 2203/00; B65D 85/78; B65D 3/06

(57) ABSTRACT

The invention is a windowed cornet package having a cornet package (10) into which the ice cream, prepared from any kind of dried and fresh fruit according to the consumer preferences, is placed, characterized in that it comprises a window (20) located on said cornet package (10) and a transparent barrier (30) connected with said window (20).

### TECHNICAL FIELD

The invention relates to an improvement made in the packages of the ice cream cornets (cones) that are preferred by the consumers in all the seasons.

The invention comprises a windowed section on the package.

### STATE OF THE ART

Today, the ice cream is a food rich in vitamins, calcium, fat, protein and phosphorus, consumed in all the seasons with a notably higher consumption rate during the summer months. In general, it is quite easy to access any kind of ice cream packaged in a state ready for service.

In addition to the ice creams that are prepared with all kinds of dried and fresh fruits, the product types such as walnut ice cream, vanilla ice cream, chocolate ice cream, caramel ice cream, etc. are also frequently consumed in the marketplace. However, the interior of the product is not visible in the packaged products where the preference for the product is made based on only the writing on the package. Thus, the consumer inclines to buy the product directly by way of reading the written phrase.

Moreover, the manufacturer companies prefer to include only the information about the product contents on the package. There is not present a section that contains the features such as logo, advertisement, etc. in a particular area. However, the increase in the sales of a company means an increased market share. It is the advertising that enables the consumers to become inclined to prefer the products of a particular company among all the products available in the market sections. The consumers are motivated to recognize and demand the products of a respective company through the addition of attention-grabbing and distinguishing features to the designs and logos being advertised.

Consequently, due to the drawbacks mentioned above and the inadequacy of the existing solutions in this regard, it has become necessary to perform an improvement in the relevant technical field.

### BRIEF DESCRIPTION OF THE INVENTION

The present invention relates to a windowed cornet package, which satisfies the aforesaid requirements, eliminates all the disadvantages and provides some additional advantages.

The ultimate object of the invention is to provide a windowed section on the package.

Another object of the invention is to enable the visual feature of window on the package to be in the form of company logos and other geometric figures.

Another object of the invention is to enable the product inside the package to be seen by the consumer without the touch of hands or without being affected by the external factors, owing to a transparent barrier on the window.

Another object of the invention is to provide a package that s suitable for the health of food.

Another object of the invention is to generate a motivating effect and provide contribution in the sales by providing the consumer with the ability to see the interior of the package owing to the transparent barrier.

Another object of the invention is to provide the ability to readily generate an advertisement area owing to the window.

### BRIEF DESCRIPTION OF THE FIGURES

FIG. 1: A perspective view of the product according to the invention

### REFERENCE NUMERALS

10. Cornet package
20. Window
30. Transparent barrier

### DETAILED DESCRIPTION OF THE INVENTION

In this detailed description, the preferred embodiments of the windowed ice cream cornet package according to the invention will be described only for the purpose of enabling a better understanding of the subject matter, in a way not leading to any limiting effect.

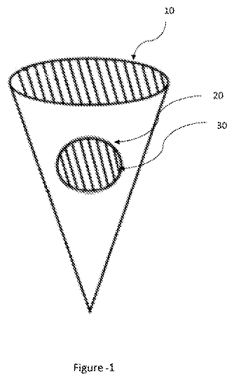

The product according to the invention comprises the cornet package (10) into which the ice cream, prepared from any kind of dried and fresh fruit according to the consumer preferences, is placed, the window (20) disposed on the cornet package (10) and the transparent barrier (30) on the window (20) for enabling the interior of the cornet package (10) to become visible (FIG. 1).

The cornet package (10) consists of 3 layers. These are OPP, aluminum and paper layers. The package is shaped during the pressing according to the contents of the ice cream. There is present a window (20) on the cornet package (10), said window being intended to enable a certain part of the product inside the cornet package (10) to become visible without opening said package.

The window (20) may bear any desired geometric figure or logo. It may also be used as an advertisement area.

The window (20) comprises thereon a transparent barrier (30). In this way, it becomes possible to view the product inside the package without the touch of hands or without the product being affected by the external factors.

1. A windowed cornet package having a cornet package (10) into which the ice cream, prepared from any kind of dried and fresh fruit according to the consumer preferences, is placed, characterized in that it comprises
a window (20) located on said cornet package (10),
a transparent barrier (30) connected with said window (20).

2. Windowed cornet package according to claim 1 characterized in that a transparent barrier (30), which enables the interior of the cornet package (10) to become visible, is disposed on the window (20).

3. Windowed cornet package according to claim 1 characterized in that the window (20) has any desired geometric figure.

4. Windowed cornet package according to claim 1 characterized in that it is possible to apply an advertisement area on the window (20).
